(19) United States
(12) Patent Application Publication
(10) Pub. No.: US 2005/0286574 A1
(43) Pub. Date: Dec. 29, 2005

(54) Microwave light emitter with a self-pulsating layer

(75) Inventor: Guang-Hua Duan, Chatenay Malabry (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/156,547

(22) Filed: Jun. 21, 2005

(30) Foreign Application Priority Data
Jun. 23, 2004 (FR) 04 51 315

(51) Int. Cl. H01S 3/10

(52) U.S. Cl. 372/28

(57) ABSTRACT

The light emitter comprises a self-pulsating laser (2) producing a self-pulsating signal at a given self-pulsating frequency (f_{SP}) and a modulator device (3) suitable for generating a frequency shift keyed signal (FSP) about a frequency corresponding to a subharmonic (f_{SP}/n) of the self-pulsating frequency of the laser. The modulator circuit is designed to enable the self-pulsating signal to be synchronized by a harmonic of the generated encoded signal. The self-pulsating laser is modulated by a signal at a carrier frequency corresponding to a subharmonic (f_{SP}/n) of the self-pulsating frequency of the laser, thus enabling phase noise to be eliminated from the self-pulsating signal (f_{SP}) by ensuring perfect phase-locking between the self-pulsating signal and the modulated signal. Such an emitter is particularly suitable for application in a radiofrequency transmitter unit using a light medium.

The present invention relates to the field of light emitters, and in particular so-called “microwave” light emitters for radio applications.

The invention applies to hybrid radio systems that use microwave light emitters to amplitude modulate an emitted light carrier wave in such a manner as to encode a signal for transmission in the form of modulation applied to a microwave carrier (sometimes also referred to as a subcarrier or a radio carrier or an RF carrier). This subcarrier modulated as a function of the signal itself constitutes a signal modulating the optical carrier wave. The microwave optical signal as obtained in this way is coupled into a transmission fiber. On reception, a photodiode converts the modulated optical signal into an RF electrical signal and forwards it to a radio antenna.

Transmitting a radio signal over an optical fiber enables broadband transmission to be performed from a central transmitter unit to remote antenna unit. Two known types of radio system offer broadband access. There is the local microwave distribution system (LMDS) that transmits at about 40 gigahertz (GHz) at a data rate of about 25 megabits per second (Mbit/s); and there is the mobile broadband system (MBS) that transmits around 60 GHz at a date rate of about 155 Mbit/s.

A signal at 40 GHz or 60 GHz can be transmitted from a transmitter unit to the antennas by means of an optical fiber, such as a conventional single-mode fiber (SMF).

The light emitter at such a central transmitter unit serves to generate a microwave light signal for delivery to the antennas. For this purpose, information, e.g. binary information corresponding to “0s” and “1s” needs to be encoded onto the microwave signal. The receiving photodiode at the antenna serves to convert the radio frequency light signal transmitted over the fiber into an electrical signal.

Various techniques have been proposed in the prior art to generate and encode the microwave light signal for emitting into a transmission fiber.

One solution implemented in existing hybrid radio systems consists in using a continuously-emitting monomode laser associated with an electro-absorption modulator, or any type of modulator such as a lithium niobate (LINbO₃) Mach-Zehnder modulator. The modulator is located downstream from the laser and serves to modulate the light signal at a frequency in the microwave range.

The binary information for transmission is encoded on the microwave carrier. Nevertheless, that solution is expensive since components suitable for use at high frequencies, i.e. 40 GHz or 60 GHz, are themselves still expensive.

Another solution consists in using beats between two lasers each emitting at a given wavelength. A photodiode is then suitable for generating a microwave signal at a frequency corresponding to the difference between the frequencies of the emitted wavelengths. With such a solution, there is no need to use high frequency modulators since a microwave light signal is generated at a frequency corresponding to the difference between the frequencies of the wavelengths emitted by the two lasers.

One such solution is described in particular in the publication “Packaged semiconductor laser optical phase-locked loop (OPLL) for photonic generation, processing and transmission of microwave signals”, by L. N. Langley et al., IEEE Transactions on Microwave Theory and Techniques, Vol. 47, No. 7, July 1999. Light signals from a master laser and from a slave laser are coupled in an optical fiber and sent to a photodiode which detects the signals. According to that publication, proposals are also made to implement a phase-locked loop by acting on the slave laser to reduce the phase noise generated by the microwave signal because the two lasers are not accurately in phase with each other.

The publication “Low-phase-noise millimeter-wave generation at 64 GHz and data transmission using optical sideband injection locking” by R. P. Braun et al., IEEE Photonics Technology Letters, Vol. 10, No. 5, May 1998 also proposes generating a microwave signal from beats between two lasers. A master laser is modulated with a subharmonic of the radio frequency to be transmitted. Modulation side bands are then generated. A reference laser and a slave laser are then each locked on one of the modulation sidebands. The microwave signal is generated from the signals emitted by the reference and slave lasers. The phase noise of the resulting microwave signal is indeed reduced since the reference laser and the slave laser are in phase by being synchronized to two modulation sidebands of the master laser. In addition, the slave laser is modulated to encode the signal for conveying to the antennas.

Nevertheless, those solutions require a plurality of lasers to be used, which involves extra expense.

Another solution consists in using a self-pulsating laser to emit a microwave signal at the self-pulsating frequency of the laser. So-called “self-pulsating lasers” emit light power that varies over time even when the current injected into the laser structure remains constant. One type of self-pulsating laser is a semiconductor longitudinal multimode laser. Thus, two or more modes are emitted simultaneously at at least two distinct wavelengths. The self-pulsating frequency of the laser is equal to the difference between the frequencies of those two modes.

Various structures can be envisaged for making self-pulsating lasers of the longitudinal multimode type. Those structures include self-pulsating distributed feedback (DFB) lasers, comprising two active sections coupled to a phase control section. Each active section of that type of laser device includes a Bragg grating. The two Bragg gratings in that type of device have different periods, such that the laser oscillates simultaneously on two wavelengths. Reference can be made to publication “Modeling of mode control and noise in self-pulsating phase comb lasers” by H. J. Wunsche et al., IEEE Selected Topics in Quantum Electronics, Vol. 9, Issue 3, May-June 2003, pp. 857-864.

There also exist self-pulsating distributed Bragg reflector (DBR) laser devices comprising an active first section defining an active waveguide and a passive second section defining a passive waveguide having a distributed Bragg reflector. An appropriate selection for the length of the Bragg section enables a laser effect to be obtained over a plurality of modes. Mode beats in that type of laser enable the various modes to be synchronized in phase because of non-linear effects. Reference can be made to the publication “Analysis of self-pulsation in distributed Bragg reflector laser based on four-wave mixing” by P. Landais, J. Renaudier, P. Gaillon, and G. H. Duan, Photonics West, 2004.

The publication “Optical millimeter-wave generation and wireless data transmission using dual mode laser” by G. Grosskopf et al., IEEE Photonics Technology Letters, Vol. 12, No. 12, December 2000, proposes encoding a light signal emitted by a self-pulsating laser at a point downstream from the emission of the light signal. A Mach-Zehnder modulator applies appropriate encoding to the emitted self-pulsating signals. Nevertheless, that solution requires an additional modulator component. The phase noise of the generated microwave signal is indeed reduced by the fact that the signal is synchronized relative to a modulating electrical signal, as is described in the publication “Optical microwave source” by S. Bauer et al., Electronics Letters, Vol. 38, No. 7, Mar. 28, 2002.

In order to reduce the number of components used, one solution may then consist in modulating the self-pulsating laser directly. For this purpose, a modulation signal is applied to one or the other of the active or Bragg sections in order to modify the refractive index of said section and thus vary the self-pulsating frequency.

Such a solution is described in the publication “Self-pulsating laser diode as fast-tunable FSK transmitters in subcarrier multiple access networks” by J. G. Georges and K. Y. Lau, IEEE Photonics Technology Letters, Vol. 5, No. 2, February 1993. A self-pulsating laser is modulated by an electrical signal corresponding directly to the binary information to be transmitted. Binary information corresponding to “0s” is represented by one specific electric voltage U₀, and binary information corresponding to “1s” is represented by another specific electric voltage U₁. Thus, when the control voltage applied to the self-pulsating laser is U₀, the laser emits its modes with a certain self-pulsating frequency, and when the control voltage applied to the laser U₁₁ the self-pulsating laser emits its modes with another self-pulsating frequency.

Nevertheless, the self-pulsating signal generally presents a significant amount of phase noise that can lead to errors on reception.

The present invention seeks to solve the drawbacks of the prior art and to provide a light emitter comprising a self-pulsating laser that is modulated in such a manner that the various modes emitted are phase-locked. The phase noise conveyed with the microwave signal is thus considerably reduced and the quality of the signal is improved. Simultaneously, the binary information for transmission is encoded on the frequency of the signal modulating the self-pulsating laser.

To this end, the invention provides a microwave light emitter comprising:
a self-pulsating laser suitable for producing a self-pulsating signal having a given self-pulsating frequency; and
a modulator device suitable for generating a signal encoded by frequency shift keying or by phase shift keying about a frequency corresponding to a subharmonic of the self-pulsating frequency of the self-pulsating laser;
the modulator device being arranged to influence a physical parameter of said self-pulsating laser in response to said generated encoded signal, said influence being applied with sufficient power to enable the self-pulsating signal to be synchronized with a harmonic of the generated encoded signal.

In practice, a physical parameter that is easy to influence is typically the refractive index and/or the gain of a light guide forming part of the self-pulsating laser.

In an embodiment, the modulator device is an electrical modulator circuit.

According to a characteristic, the electrical modulator circuit comprises a variable frequency oscillator controlled by an electrical encoding signal.

According to a characteristic, the encoded signal generated by the electrical modulator circuit is a control current applied to the self-pulsating laser.

In another embodiment, the modulator device is an electro-optical modulator circuit delivering said generated encoded signal in the form of a light signal and arranged to inject said light signal into a light guide constituting the self-pulsating laser.

According to a characteristic, the electro-optical modulator circuit comprises a single-mode master laser suitable for being modulated by an electronic circuit.

According to a characteristic, the master laser emits a single-mode light signal modulated about a subharmonic of the self-pulsating frequency of the self-pulsating laser.

According to a characteristic, the electro-optical modulator circuit comprises an electronic circuit comprising a variable frequency oscillator controlled by an electrical encoding signal, and delivering a control current to the master laser.

Thus, the encoded signal generated by the electro-optical modulator circuit is a light signal that is amplitude-modulated at the rate of a frequency that varies about a subharmonic of the self-pulsating frequency, said light signal being coupled into the self-pulsating laser.

In an embodiment, the self-pulsating laser is a Bragg reflector laser.

In an embodiment, the self-pulsating laser is a distributed feedback laser.

The invention applies to an RF transmitter unit including a light emitter of the invention coupled to a transmission fiber.

The features and advantages of the invention appear more clearly on reading the following description given by way of illustrative and non-limiting example, and made with reference to the accompanying figures, in which:

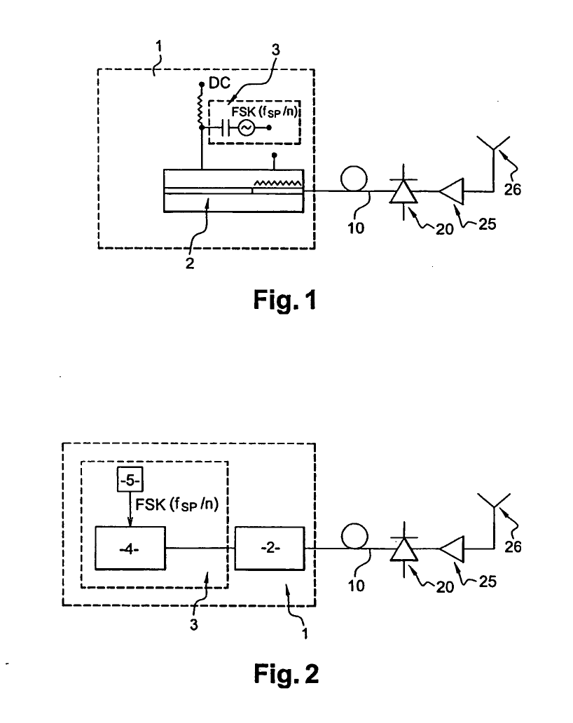

FIG. 1 is a theoretical diagram of a hybrid radio system including an emitter constituting a first embodiment of the invention; and

FIG. 2 is a theoretical diagram of a hybrid radio system including an emitter constituting a second embodiment of the invention.

The light emitter of the invention comprises a self-pulsating laser emitting a microwave signal at the self-pulsating frequency (f_{SP}) of the laser, and a modulator circuit suitable for generating a signal encoded by frequency shift keying (FSK) about a frequency corresponding to a subharmonic (f_{SP}/n, where n=1, 2, 3, . . . ) of the self-pulsating frequency of the laser. The modulator circuit is disposed so as to influence a physical parameter of said self-pulsating laser in response to the generated encoded signal so as to enable the self-pulsating signal to be synchronized with a harmonic of the generated encoded signal.

Modulating the self-pulsating laser by means of a signal at a frequency corresponding to a subharmonic (f_{SP}/n) of the self-pulsating frequency of the laser makes it possible to eliminate phase noise from the self-pulsating signal (f_{SP}) by using mode beats to create accurate phase-locking between the modes emitted by the self-pulsating laser. In addition, encoding by frequency shift keying takes place in the modulator circuit.

Such an emitter finds particular applications in a radio frequency transmitter unit that makes use of an optical medium.

The emitter of the invention is described in greater detail for a first embodiment shown diagrammatically in FIG. 1.

Such an emitter 1 comprises a self-pulsating laser 2 emitting in conventional manner a wave that presents a multimode spectrum. The laser 2 shown in FIG. 1 is a DBR type laser as described above, but any other known type of self-pulsating laser could equally well be envisaged, such as a DFB laser or a phase-comb laser.

The laser 2 is dimensioned so as to emit distinct modes at given frequencies separated by the self-pulsating frequency f_{SP} of the laser. This self-pulsating frequency f_{SP} depends on the laser and also on the current being injected into the laser. A microwave light signal at this self-pulsating frequency f_{SP} will thus be generated that can be transformed into a pure microwave signal by a photodiode, as described above.

The laser 2 is biased with direct current DC injected into the active section of the laser via a bias resistor. Any other circuit suitable for establishing bias could be envisaged, depending on the type of laser used.

The emitter of the invention also comprises a modulator circuit 3. This circuit 3 is adapted to generate a subcarrier at a frequency close to a subharmonic f_{SP}/n of the self-pulsation frequency f_{SP} of the laser. The subcarrier is also subjected to frequency shift keying (FSP) in conventional manner as a function of an information signal for transmission.

The modulator circuit 3 thus receives a basic electrical signal as input for encoding purposes corresponding to the binary information that is to be transmitted, and at its output it delivers a signal that is encoded by FSK about the subharmonic f_{SP}/n. The modulator circuit 3 may include a variable frequency oscillator controlled by the input binary electrical signal. Thus, for example, “0” state data is encoded by the modulator circuit at the frequency f_{SP}/n, while “1” state data is encoded at the frequency (f_{SP}+Δf_{SP})/n.

In the embodiment shown in FIG. 1, the modulator circuit 3 is a purely electrical circuit. The encoding electrical signal may be a current or a voltage that can be varied depending on whether the data for encoding is a “0” or a “1”. By way of example, the modulator circuit delivers at its output an alternating current (AC) at the frequency f_{SP}/n or (f_{SP}+Δf_{SP})/n respectively representing data of value “0” or of value “1” in the information for transmission.

The current supplied by the modulator circuit 3 is injected into the laser 2 and constitutes control current for the laser. The self-pulsating laser is thus not controlled by modulating current presenting the binary signal that is to be encoded in baseband, but by current that is modulated by frequency shift keying about a subharmonic of the self-pulsating frequency of the laser.

Applying such a control current serves to modulate the refractive index and/or the gain of the light guide of the self-pulsating laser, thereby generating modulation sidebands on either side of the light frequencies corresponding to the various modes of the self-pulsating laser that are spaced apart by f_{SP}, the sidebands being offset from those frequencies by integer multiples of f_{SP}/n, i.e. harmonics of f_{SP}/n. The modes created by the self-pulsating laser will then become synchronized relative to those sidebands. The modes emitted by the laser 2 will thus indeed be phase-locked and the phase noise transmitted with the microwave signal will be considerably reduced.

For example, if the self-pulsation frequency of the laser is 40 GHz, an encoding subharmonic may be 10 GHz. The FSK applied to said subharmonic may take place at a rate of 144 Mbit/s with a modulation factor of 0.1. The frequency of the electrical signal applied to the laser will thus be either 10 GHz, or 10+0.1×0.144 GHz, depending on the binary state of the laser to be transmitted.

The modulator signal 3 thus supplies the laser 2 with a control signal in the capture band of the self-pulsating frequency. Thus, one of the modulation harmonics will be close enough to the self-pulsating frequency, and if the power of this control signal is adjusted to a sufficient level, it is certain that the self-pulsating signal and the modulating signal will become phase-locked. In the above example, the self-pulsating frequencies of the encoded signal are locked on either side of 4×10 GHz and on either side of 4×(10+0.1×0.144) GHz.

Thus, the self-pulsating frequency of the signal switches between two values depending on the binary state of the data to be transmitted, but this variation alternates between modes that are locked in phase. The phase noise associated with non-synchronization of the emitted modes can thus be eliminated in an emitter of the invention.

The laser 2 then emits the signal as frequency encoded in this way into a transmission optical fiber 10, and a photodiode 20 detects the light signal, which signal, after being amplified at 25, is forwarded in the form of a microwave electrical signal to an antenna 26.

In another embodiment, shown in FIG. 2, the modulator device 3 is an electro-optical circuit. All elements that are identical or equivalent to elements in the embodiment of FIG. 1 are given the same reference numerals.

In this second embodiment, the modulator circuit 3 comprises an electronic circuit 5 and a single-mode master laser 4 that can be modulated at high frequency. The master laser 4 emits a light signal that is coupled into the self-pulsating laser 2, i.e. this light signal is injected into the light guide of the self-pulsating laser 2 in such a manner as to influence the refractive index and/or the gain of the light guide.

The master laser 4 can be modulated by an electronic circuit 5 delivering an electrical signal that is modulated about a subharmonic (f_{SP}/n) of the self-pulsating frequency. The electronic circuit 5 delivers a control signal for application to the master laser 4. The electronic circuit 5 is designed to generate a signal modulated by frequency shift keying about a subharmonic f_{SP}/n of the self-pulsating frequency of the laser.

The modulating electronic circuit 5 thus receives as input an electrical signal in baseband corresponding to the binary information for transmission, and it outputs an electrical signal that is frequency modulated as a function of said information. The electronic circuit 5 may be of the same type as the modulator circuit 3 described with reference to the first embodiment.

The electrical signal supplied by the circuit 5 may thus be alternating current at a frequency f_{SP}/n or (f_{SP}+Δf_{SP})/n representing respectively the “0” state and the “1” state of the information to be transmitted. The current delivered by the electrical circuit 5 is a control current for the master laser 4.

The master laser 4 then emits a single-mode light signal that is modulated either at a frequency f_{SP}/n or at a frequency (f_{SP}+Δf_{SP})/n. Providing the power of this light signal is adjusted to a sufficient level, the self-pulsating laser 2 will become synchronized on the modulating frequency of the master laser 4. Since this modulating frequency is equal to or close to a subharmonic of the self-pulsating frequency f_{SP} of the laser 2, the modulation sidebands of the self-pulsating laser will be close enough to the self-pulsating modes for them to be locked by the modulation bands. The various modes emitted by the self-pulsating laser are then indeed phase-locked.

This second embodiment differs from the first in that the self-pulsating laser is frequency modulated by a light control signal instead of by an electrical control signal. The second embodiment is more expensive to implement because it uses an additional component (the master laser). Nevertheless, this embodiment can be useful when the self-pulsating laser is not suitable for being directly modulated by a current control signal at a subharmonic of the self-pulsating frequency. The modulation passband of a laser is limited both intrinsically by the frequency of relaxation oscillations, and also extrinsically by structure and by configuration. Thus, if the self-pulsating laser cannot be modulated by the desired subharmonic of the self-pulsating frequency, then it becomes necessary to use a master laser that can be modulated at said subharmonic.

Although the above description relates to the encoded signal being the result of frequency shift keying about a frequency corresponding to a subharmonic of the self-pulsating frequency of the self-pulsating laser, the invention can be applied if the signal is encoded by phase modulation about the same subharmonic.

1. A microwave light emitter (1) comprising:
a self-pulsating laser (2) suitable for producing a self-pulsating signal having a given self-pulsating frequency (f_{SP}); and
a modulator device (3) suitable for generating a signal encoded by frequency shift keying (FSK) or by phase shift keying about a frequency corresponding to a subharmonic (f_{SP}/n, for n integer and >1) of the self-pulsating frequency of the self-pulsating laser (2);
the modulator device (3) being arranged to influence a physical parameter of said self-pulsating laser (2) in response to said generated encoded signal, said influence being applied with sufficient power to enable the self-pulsating signal to be synchronized with a harmonic of the generated encoded signal.

2. A light emitter according to claim 1, characterized in that said physical parameter is the refractive index and/or the gain of a light guide constituting the self-pulsating laser (2).

3. A light emitter according to claim 1 or claim 2 claim 1, characterized in that the modulator device is an electrical modulator circuit.

4. A light emitter according to claim 3, characterized in that the electrical modulator circuit comprises a variable frequency oscillator controlled by an electrical encoding signal.

5. A light emitter according to claim 3, characterized in that the encoded signal generated by the electrical modulator circuit is a control current applied to the self-pulsating laser.

6. A light emitter according to claim 1, characterized in that the modulator device is an electro-optical modulator circuit delivering said generated encoded signal in the form of a light signal and arranged to inject said light signal into a light guide constituting the self-pulsating laser (2).

7. A light emitter according to claim 6, characterized in that the electro-optical modulator circuit comprises a single-mode master laser (4) suitable for being modulated by an electronic circuit (5).

8. A light emitter according to claim 7, characterized in that the master laser (4) emits a single-mode light signal modulated about a subharmonic (f_{SP}/n) of the self-pulsating frequency of the self-pulsating laser (2).

9. A light emitter according to claim 6, characterized in that the electro-optical modulator circuit comprises an electronic circuit (5) comprising a variable frequency oscillator controlled by an electrical encoding signal, and delivering a control current to the master laser (4).

10. A light emitter according to claim 1, characterized in that the self-pulsating laser is a Bragg reflector (DBR) laser.

11. A light emitter according to claim 1, characterized in that the self-pulsating laser is a distributed feedback (DFB) laser.

12. A radiofrequency transmitter unit comprising a light emitter according to any one of claims 1 coupled to a transmission fiber (10).
